(19) United States
(12) Patent Application Publication
(10) Pub. No.: US 2025/0185553 A1
(43) Pub. Date: Jun. 12, 2025

(54) RAIN TRIGGERING BY HIGH-REPETITION RATE HIGH-PEAK POWER LASER-INDUCED SHOCK WAVE

(71) Applicant: Technology Innovation Institute - Sole Proprietorship LLC, Masdar City (AE)

(72) Inventors: Antaryami Mohanta, Abu Dhabi (AE); Guillaume Matras, Abu Dhabi (AE)

(73) Assignee: Technology Innovation Institute - Sole Proprietorship LLC, Masdar City (AE)

(21) Appl. No.: 18/974,950

(22) Filed: Dec. 10, 2024

Related U.S. Application Data
(60) Provisional application No. 63/608,525, filed on Dec. 11, 2023.

(51) Int. Cl. A01G 15/00; G01W 1/08; H01S 3/10

(52) U.S. Cl. CPC A01G 15/00; G01W 1/08; H01S 3/10046

(57) ABSTRACT

A method for weather modification and precipitation enhancement can include transmitting a beam of a pulsed laser to promote interactions in clouds by generating shock wave and acoustic wave in the clouds. A repetition rate of the pulsed laser can be between about 1 kHz and about 200 kHz, which can be modulated arbitrarily. The interactions can induce convection and turbulence within the clouds, improving a collision-coalescence process and facilitating effective precipitation from the clouds. Furthermore, the method involves the arbitrary modulation of the repetition rate of the pulsed laser, which can generate acoustic waves with a wide range of frequencies. This capability can lead to acoustic agglomeration and, in turn, enhance the collision-coalescence process for precipitation. The method can further include steering the beam in a helical or spiral path to increase a scale of rainfall enhancement. A chemical-free nature of the method may provide an environmental friendly alternative to traditional cloud seeding methods for rain induction.

### CROSS-REFERENCE TO RELATED APPLICATIONS

This application claims the benefit of U.S. Provisional Patent Application No. 63/608,525, entitled “Rain Triggering by High-repetition Rate High-peak Power Laser-induced Shock Wave,” filed on Dec. 11, 2023, which is incorporated by reference herein in its entirety.

### BACKGROUND

### Field

Embodiments generally relate to methods and systems of modifying weather by triggering rain, especially in arid or drought-prone regions, using advanced laser technology.

### Background Art

Rain induction methods involve artificially generating or enhancing precipitation of clouds. Cloud seeding is a widely employed technique for enhancing rainfall by introducing cloud seeding agents (commonly silver iodide or calcium chloride) into clouds to promote the formation of ice crystals or raindrops, which ultimately lead to increased rainfall. Other techniques of rain induction in practice or under experimental research include aerosol spraying, artificial ice nucleation, acoustic and sonic methods, airborne flares and rockets, and atmospheric moisture enhancement. The effectiveness of many of these methods can vary depending on atmospheric conditions.

### SUMMARY

Embodiments of methods and systems for triggering rain using high repetition rate, high peak power pulsed lasers are described herein.

In some embodiments, a method can include generating a beam from a pulsed laser, transmitting the beam into a cloud, and steering the beam according to a pattern in the cloud. A repetition rate of the pulsed laser can be between about 1 kHz and about 200 kHz and can be modulated arbitrarily. A peak power of the pulsed laser can be between about 10 GW and about 50 GW, making it capable of creating plasma in the cloud. The beam transmitted into the cloud can induce a shock wave and/or an acoustic wave in the cloud. The arbitrary modulation of the repetition rate of the pulsed laser beam can lead to the generation of a wide range of acoustic wave frequencies required for the effective promotion of particle agglomeration in the cloud. The steering pattern can enhance an amount of precipitation and/or decrease a time period before the precipitation from the cloud.

In some embodiments, a system can include a remote sensor and a pulsed laser. The remote sensor can be configured to monitor a changing condition of a cloud. The pulsed laser can be configured to transmit a beam of laser into the cloud to enhance a precipitation of the cloud, in response to the changing condition of the cloud. A repetition rate of the pulsed laser can be between about 1 kHz and about 200 kHz and can be modulated arbitrarily. A peak power of the pulsed laser can be between about 10 GW and about 50 GW, making it capable of creating plasma in the cloud.

These as well as additional features, functions, and details of various embodiments are described below. Similarly, corresponding and additional embodiments are also described below.

### BRIEF DESCRIPTION OF THE DRAWINGS/FIGURES

Aspects of this disclosure are best understood from the following detailed description when read with the accompanying figures. It is noted that, in accordance with the common practice in the industry, various features are not drawn to scale. In fact, the dimensions of the various features may be arbitrarily increased or reduced for clarity of discussion.

FIG. 1 illustrates a schematic diagram of a system, in accordance with some embodiments.

FIG. 2 illustrates a schematic diagram of a dynamical process, in accordance with some embodiments.

FIGS. 3A and 3B illustrate schematic diagrams of transmitting laser beams with different focusing configurations into a cloud, in accordance with some embodiments.

FIG. 4 illustrates a schematic diagrams of steering a laser beam to relocate particles in a cloud, in accordance with some embodiments.

FIG. 5 illustrates a flowchart of a method, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the process for performing a first operation and performing a second operation in the description that follows can include embodiments in which the first and second operations are performed in sequence, and can also include embodiments in which additional operations can be performed between the first and second operations, such that the second operation cannot be performed right after the first operation. In addition, the present disclosure can repeat reference numerals and/or letters in the various examples. This repetition does not in itself dictate a relationship between the various embodiments and/or configurations discussed.

Spatially relative terms, such as “beneath,” “below,” “lower,” “above,” “upper,” and the like can be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus can be otherwise oriented (rotated 90 degrees or at other orientations) and the spatially relative descriptors used herein can likewise be interpreted accordingly.

It is noted that references in the specification to “one embodiment,” “an embodiment,” “an example embodiment,” “exemplary,” etc., indicate that the embodiment described can include a particular feature, structure, or characteristic, but every embodiment can not necessarily include the particular feature, structure, or characteristic. Moreover, such phrases do not necessarily refer to the same embodiment. Further, when a particular feature, structure or characteristic is described in connection with an embodiment, it would be within the knowledge of one skilled in the art to affect such feature, structure or characteristic in connection with other embodiments whether or not explicitly described.

It is to be understood that the phraseology or terminology herein is for the purpose of description and not of limitation, such that the terminology or phraseology of the present specification is to be interpreted by those skilled in relevant art(s) in light of the teachings herein.

In some embodiments, the terms “about” and “substantially” can indicate a value of a given quantity that varies within 5% of the value (e.g., +1%, +2%, +3%, +4%, +5% of the value). These values are merely examples and are not intended to be limiting. The terms “about” and “substantially” can refer to a percentage of the values as interpreted by those skilled in relevant art(s) in light of the teachings herein.

In some aspects, weather modification, and in particular, rain induction is an important approach to mitigate the issue of water scarcity, especially in arid and drought-prone regions. Cloud seeding can enhance rainfall. Seeding chemicals used in cloud seeding could produce negative impact on the environment. Other aspects include aerosol spraying, artificial ice nucleation, acoustic and sonic methods, airborne flares and rockets, and atmospheric moisture enhancement that may introduce external chemical agents in the atmosphere and may not always guarantee desired results.

In some aspect, ultra-high-power compact ultrafast laser technology can be used for rain triggering methods using high-intensity laser beams. In some aspects, 800 nm laser pulses can be used to initiate rain formation, primarily in controlled settings with limited real-world experiments. Other aspects can use ultrashort ultra-violet (UV) laser pulses, which may use fewer photons for rain initiation but may introduce atmospheric propagation challenges and safety concerns. In other aspects, ultrafast lasers with limited repetition rates (1 kHz in cloud chambers and 10 Hz in the atmosphere) can be used that restrict the frequency of interactions with the medium. In other aspects, additional cloud condensation nuclei (CCNs) through the interaction of femtosecond lasers with air molecules can be used. In some aspects, introducing extra CCNs into a dusty cloud may lead to disrupting the delicate balance required for rain enhancement and could shift atmospheric conditions from super-saturation to saturation or unsaturation, which can be counterproductive for precipitation.

The embodiments described herein are directed to address the above challenges. In some embodiments, a method of inducing rain in a cloud can implement a pulsed laser with a high repetition rate and a high peak-power. In some embodiments, the pulsed laser can have a repetition rate between about 1 kHz and about 200 kHz, which can be modulated arbitrarily. In some embodiments, the pulsed laser can transmit a beam of laser into a cloud, and the beam of laser with the high repetition rate and the high peak-power can generate shock waves and acoustic waves in the cloud to promote a collision-coalescence process in the cloud, which benefits the enhancement of precipitation from the cloud. In some embodiments, the arbitrary modulation of the repetition rate of the pulsed laser can generate acoustic waves of a wide range of frequencies, leading to acoustic agglomeration, which, in turn, varies the collision-coalescence process. In some embodiments, the beam of laser can be steered to expand a coverage of the shock waves and the acoustic waves in the cloud to vary a scale of the rainfall enhancement. In some embodiments, a method may not rely on the creation of extra cloud condensation nuclei (CCNs) in clouds, which can avoid disruption of the atmospheric balance. In some embodiments, a method can be chemical-free, providing an environmental friendly alternative to some cloud seeding methods.

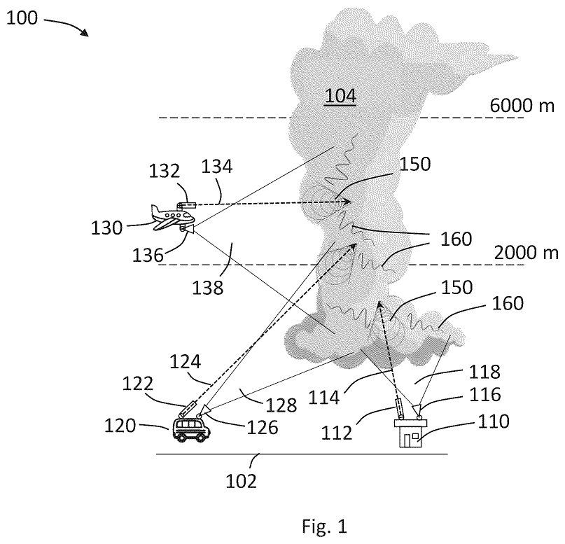

FIG. 1 illustrates a schematic diagram of a system 100, in accordance with some embodiments. For example, system 100 can be used for inducing rain by transmitting a high repetition rate, high peak power laser beam into a cloud. In some embodiments, the high repetition rate can be arbitrarily modulated. In some embodiments, system 100 can include static platforms on a ground 102 (e.g., a ground based station 110) and/or mobile platforms (e.g., a ground based vehicle 120 on ground 102 and an air based vehicle 130 at an elevated altitude above ground 102) equipped with remote sensing apparatus for collecting information about clouds (e.g., cloud 104) and/or lasers for triggering rains from the clouds.

In some embodiments, ground based vehicle 120 can be equipped with a remote sensor 126 and a laser 122. In another example, air base vehicle 130 can be equipped with a remote sensor 136 and a laser 132. In a third example, ground based station 110 can be equipped with a remote sensor 116 and a laser 112. In some embodiments, the static platforms and/or the mobile platforms can communicate with each other in wireless means and share the collected information about the clouds.

In some embodiments, cloud 104 can be a cloud candidate for triggering rain, based on the information about cloud 104 collected by the remote sensing apparatus (e.g., remote sensors 116, 126, and/or 136). For example, cloud 104 can be a cumulonimbus cloud, a nimbostratus cloud, or the like. In some embodiments, cloud 104 can extend in a range of altitude from below about 2000 m to beyond about 6000 m. For example, a bottom of cloud 104 can be at an altitude of about 1000 m, and a top of cloud 104 can be at an altitude of about 7000 m.

In some embodiments, ground based station 110 can be built in chosen areas where cloud 104 is formed frequently. For example, as shown in FIG. 1, ground based station 110 can be located under the bottom of cloud 104. In some embodiments, remote sensor 116 can probe conditions of cloud 104 from the bottom of cloud 104 by sending and/or receiving a signal 118. In some embodiments, laser 112 can transmit a laser beam 114 into cloud 104 from the bottom of cloud 104.

In some embodiments, ground based vehicle 120 can be deployed in areas where cloud 104 is formed. For example, as shown in FIG. 1, ground based vehicle 120 can be deployed to a location away from but close to cloud 104. In some embodiments, ground based vehicle 120 can be an automobile and can change its location. For example, ground based vehicle 120 can travel from a first location not under cloud 104 to a second location under cloud 104.

In some embodiments, remote sensor 126 can probe conditions of cloud 104 from a side and/or the bottom of cloud 104 by detecting cloud 104 using a signal 128.

In some embodiments, laser 122 can transmit a laser beam 124 into cloud 104 from the side and/or the bottom of cloud 104.

In some embodiments, air based vehicle 130 can be deployed in regions where cloud 104 is formed. In some embodiments, air based vehicle 130 can be deployed at an altitude within the range of altitude of cloud 104. For example, as shown in FIG. 1, air based vehicle 130 can be deployed to an altitude between about 2000 m and about 6000 m. In some embodiments, air based vehicle 130 can be deployed at an altitude below a bottom of cloud 104. In some embodiments, air based vehicle 130 can travel around cloud 104. In some embodiments, air based vehicle 130 can travel into cloud 104.

In some embodiments, remote sensor 136 can probe conditions of cloud 104 from the side and/or the bottom of cloud 104 or inside cloud 104 by detecting cloud 104 using a signal 138.

In some embodiments, laser 132 can transmit a laser beam 134 into cloud 104 from the side or the bottom of cloud 104.

In some embodiments, remote sensors 116, 126, and/or 136 can collect the information about cloud 104, such as the type of cloud 104, temperature and pressure of cloud 104, chemical components and their densities and distribution in cloud 104, etc. In some embodiments, remote sensors 116, 126, and/or 136 can detect an average size of cloud droplet in cloud 104. The information collected by remote sensors 116, 126, and/or 136 can be useful in determining variables for triggering rain from cloud 104, such as the locations of ground based vehicle 120 and air based vehicle 130 and parameters for configuring lasers 112, 122, and/or 132.

In some embodiments, remote sensors 116, 126, and/or 136 can be radars, and signals 118, 128, and/or 138 can be radio signals. In some embodiments, remote sensors 116, 126, and/or 136 can be optical sensors, and signals 118, 128, and/or 138 can be optical signals. In some embodiments, remote sensors 116, 126, and/or 136 can be the same type of remote sensing apparatus. In some embodiments, remote sensors 116, 126, and/or 136 can be different types of remote sensing apparatus. In some embodiments, remote sensors 116, 126, and/or 136 can scan surfaces of cloud 104. For example, as shown in FIG. 1, remote sensor 116 can scan the bottom of cloud 104, remote sensor 126 can scan the side and the bottom of cloud 104, and remote sensor 136 can scan the side of cloud 104.

In some embodiments, lasers 112, 122, and/or 132 can be pulsed lasers (e.g., femtosecond lasers) with high repetition rates and high peak powers. In some embodiments, a repetition rate of lasers 112, 122, and/or 132 can be between about 1 kHz and about 200 kHz. For example, the repetition rate can be between about 1 kHz and about 30 kHz, between about 30 kHz and about 50 kHz, between about 50 kHz and about 100 kHz, and between about 100 kHz and about 200 kHz. In some embodiments, the repetition rate can be 30 kHz. In some embodiments, repetition rate of lasers 112, 122, and/or 132 can be modulated arbitrarily.

In some embodiments, a peak power of lasers 112, 122, and/or 132 can be greater than about 20 GW, enabling them to generate the desired plasma in the cloud. In some embodiments, the peak power of the laser can be about 50 GW operating at the repetition rate of 30 kHz.

In some embodiments, lasers 112, 122, and 132 with the repetition rate and the peak power within the ranges discussed can generate shock waves 150 in cloud 104 to promote an increase an interaction frequency of the cloud droplets within cloud 104, due to the large amplitude and long propagation distance of laser beams 114, 124, and 134. Shock waves 150 can induce convection and turbulence within cloud 104, varying the collision-coalescence process, and promoting precipitation over an extensive area. In addition, shock waves 150 generated by laser beams 114, 124, and 134 can further convert into acoustic waves 160, as shown in FIG. 1. Acoustic waves 160 in cloud 104 can promote rapid particle clustering and produce large aerosol particles.

In some embodiments, the promoted precipitation by laser beams 114, 124, and 134 with high repetition rates and high peak powers can be chemical-free without introducing foreign substances into the atmosphere, reducing potential environmental and health concerns associated with the use of seeding agents and offers a more sustainable and eco-friendly approach to weather modification.

In some embodiments, parameters of laser beams 114, 124, and/or 134, such as their repetition rates, powers, wavelengths, polarizations, beam profiles, pulse durations, or the like can be tuned according to the information collected by remote sensors 116, 126, and/or 136 to promote triggering rain from cloud 104. In some embodiments, the trajectories of laser beams 114, 124, and/or 134 in cloud 104 can be adjusted according to the information collected by remote sensors 116, 126, and/or 136. In some embodiments, laser beams 114, 124, and/or 134 can be steered according to a pattern, such as a helical path or a spiral path to promote shock waves 150 to cover a wider area in cloud 104 to promote rainfall. In some embodiments, the pattern to steer laser beams 114, 124, and/or 134 can also be in other paths, such as a straight path, an elliptical path, or an irregular path, according to the information collected by remote sensors 116, 126, and/or 136.

In some embodiments, the parameters, the trajectories, and the steering pattern of laser beams 114, 124, and/or 134 can be adjusted in a real-time manner in response to the information collected by remote sensors 116, 126, and/or 136.

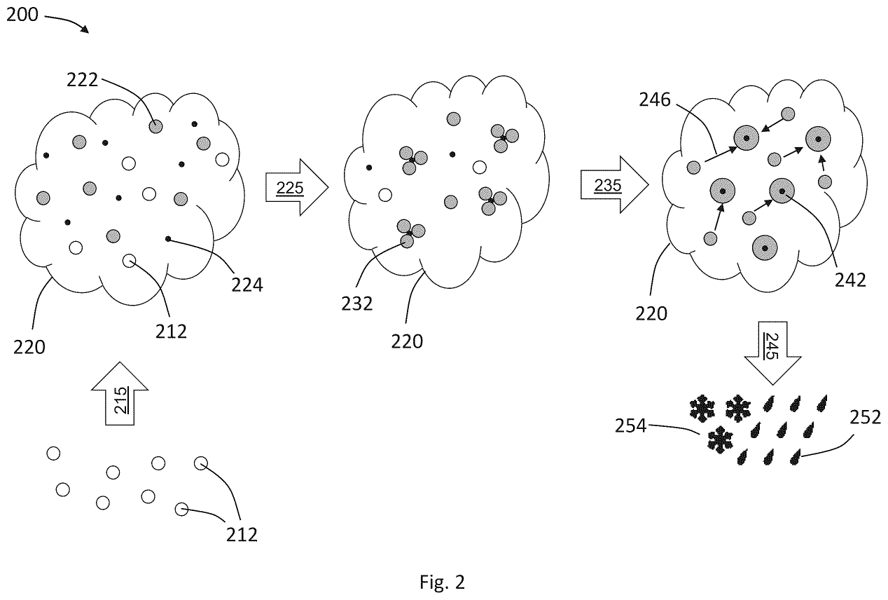

FIG. 2 illustrates a schematic diagram of a dynamical process 200, in accordance with some embodiments. For example, FIG. 2 can be used for a process of a cloud triggered by a pulsed laser beam to promote rain. In some embodiments, the pulsed laser beam can be laser beams 114, 124, and/or 134 as described with reference to FIG. 1 and can have a repetition rate and a peak power in the ranges discussed.

In some embodiments, water vapor 212 can undergo an elevation process 215 and can elevate from ground to higher altitudes to form cloud 220, which include water vapor 212, water droplets 222, and cloud condensation nuclei (CCNs) 224.

In some embodiments, cloud 220 can be cloud 104 as shown in FIG. 1. In some embodiments, cloud 220 can undergo a condensation process 225, during which water droplets 222 condensate around CCNs 224 to form cloud droplets 232.

In some embodiments, during a triggering process when the pulsed laser beam is transmitted into cloud 220, a shock wave can be generated in cloud 220 due to the high repetition rate and high peak power of the pulsed laser beam capable of producing plasma at a higher rate in the cloud, promoting a collision-coalescence process 246 in cloud 220. Collision-coalescence process 246 can promote an agglomeration of particles in cloud 220 and facilitate a growth of cloud droplets 232 by gathering surrounding water droplets 222 to form cloud droplets 242 with greater size than cloud droplets 232. Once gaining sufficient mass to descend from atmosphere, cloud droplets 242 can undergo a precipitation process 245 and fall in the form of rain 252 and/or snow 254.

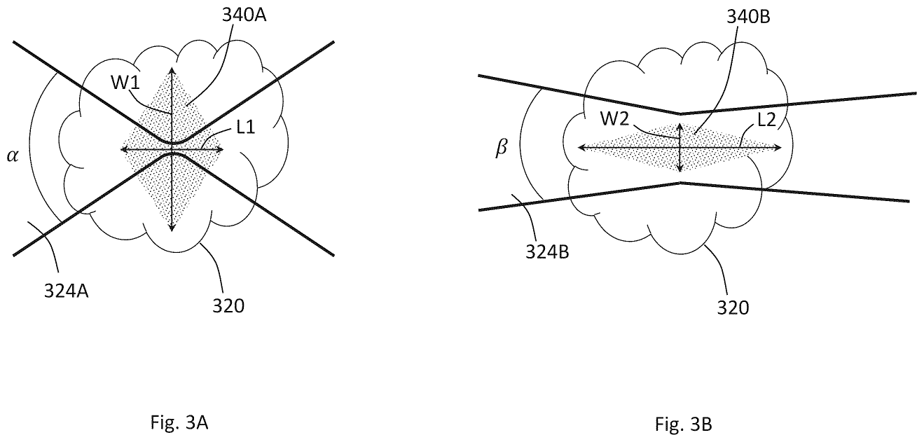

FIGS. 3A and 3B illustrate schematic diagrams of transmitting laser beams with different focusing configurations into a cloud, in accordance with some embodiments. For example, a focus configuration of the laser beam can be controlled.

In some embodiments, the focus configuration can be adjusted to control the effect of self-focusing and filament propagation of the laser beam in the cloud that can affect the induction of the shock wave and the acoustic wave. For example, a focusing angle of the laser beam can be adjusted to control a profile of a region in the cloud around which the shock wave and/or the acoustic wave are induced.

As shown in FIG. 3A, a laser beam 324A with a focusing angle a can be transmitted into a cloud 320, in which the shock wave and the acoustic wave can be induced around a region 340A with a width W1 and a length L1.

In comparison, as shown in FIG. 3B, a laser beam 324B with a focusing angle β less than angle α can be transmitted into cloud 320, in which the shock wave and the acoustic wave can be induced around a region 340B with a width W2 and a length L2. Compared with laser beam 324B, laser beam 324A may be more focused and can have a higher power intensity along a shorter distance around its plane of focus. As a result, width W1 of region 340A can be greater than width W2 of region 340B, and length L1 of region 340A can be less than length L2 of region 340B.

In some embodiments, the focusing configuration of the laser beam can be controlled in accordance with the local conditions of the cloud, for example, the densities and/or distributions of water vapor, water droplets, and cloud condensation nuclei (CCN) in the cloud detected by remote sensors (e.g., remote sensors 116, 126, and/or 136 as shown in FIG. 1).

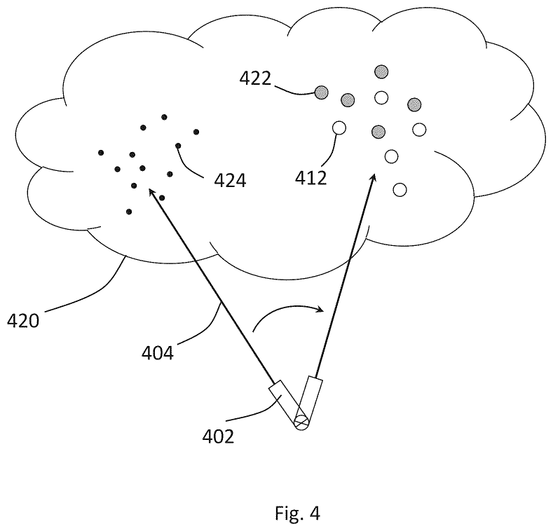

FIG. 4 illustrates a schematic diagram of steering a laser beam to relocate particles in a cloud, in accordance with some embodiments. For example, the electric field of the laser beam can be used to trap particles and transport them from one place to another.

A cloud 420 can include unevenly distributed water vapor 412, water droplets 422, and cloud condensation nuclei (CCNs) 424. A laser 402 can project a laser beam 404 first towards a region of cloud 420 where CCNs 424 are populated to capture them, and then steer beam 404 to carry CCNs 424 across cloud 420 to dispose them in a different region of cloud 420 where water vapor 412 and water droplets 422 are populated, in order to facilitate the condensation process 225 as shown in FIG. 2 to form cloud droplets 232.

In some embodiments, laser beam 404 can be steered to transport particles from remote places (e.g., on the ground or in the sky where the particles are artificially distributed) into cloud 420.

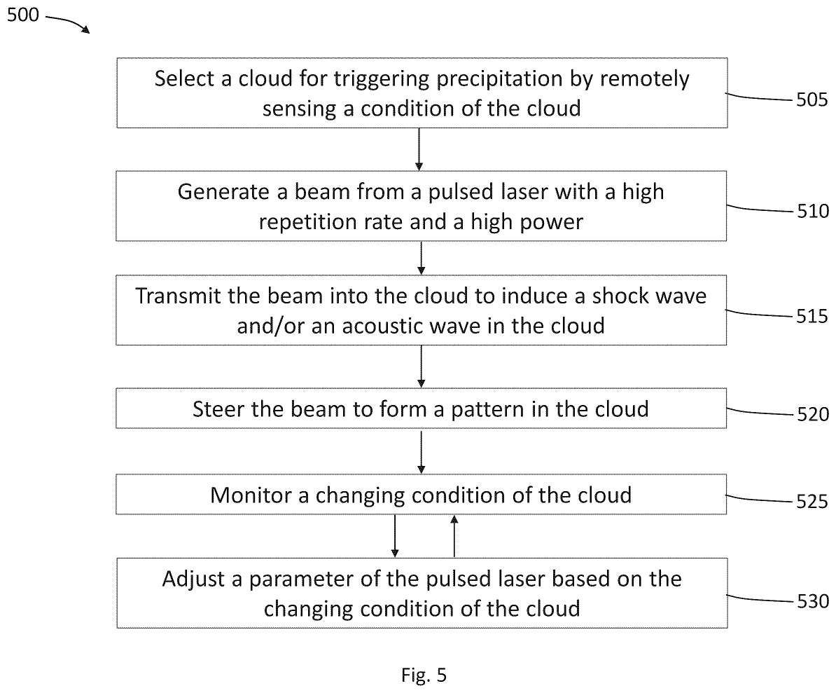

FIG. 5 illustrates a flowchart of a method 500, in accordance with some embodiments. For example, method 500 can be used to promote rain by a pulsed laser beam. In some embodiments, method 500 can focus on applying a pulsed laser beam with a repetition rate and a peak power, as described with reference to FIGS. 1 2, 3A, 3B, and 4. This disclosure is not limited to this operational description. Other operations may be performed between the various operations of method 500 and are omitted merely for clarity. Moreover, not all operations may be needed to perform the disclosure provided herein. Additionally, some of the operations may be performed simultaneously, or in a different order than the ones shown in FIG. 5. In some embodiments, one or more other operations may be performed in addition to or in place of the presently described operations.

In some embodiments, operation 505 can be used for selecting a cloud for promoting precipitation by remotely sensing a condition of the cloud. For example, as described with reference to FIG. 1, information about a condition of cloud 104 can be collected by remote sensors 116, 126, and/or 136. In some embodiments, the condition of the cloud can be a type of the cloud, a temperature of the cloud, a pressure of the cloud, a density of the cloud, a chemical composition of the cloud or the like. In some embodiments, a cloud can be selected if it is a suitable candidate for promoting rain, such as a cumulonimbus cloud or a nimbostratus cloud. In some embodiments, sensing the condition of the cloud can include deploying a mobile platform equipped with remote sensors to locations near the cloud. For example, ground based vehicle 120 can be deployed to a location such that the side and the bottom of cloud 104 can be covered by a detection range of remote sensor 126. In another example, air based vehicle 130 can be deployed to an altitude such that the side of cloud 104 can be covered within a range of altitude between about 1500 m and about 5000 m.

In some embodiments, operation 510 can be used for generating a beam from a pulsed laser with a high repetition rate and a high peak power. For example, as described with reference to FIG. 1, laser beams 114, 124, and 134 can be generated by lasers 112, 122, and 132. In some embodiments, generating the beam can include selecting a location and/or an altitude of the lasers 112, 122, and/or 132 by deploying a platform equipped with the pulsed laser to the location, such as the locations of ground based station 110, ground based vehicle 120, and air based vehicle 130. In some embodiments, selecting the location and/or the altitude of lasers 112, 122, and/or 132 can be based on the information about a condition of cloud 104 collected by remote sensors 116, 126, and/or 136 in operation 505. In some embodiments, generating the beam can include configuring a repetition rate of the pulsed laser to be between about 1 kHz and about 200 kHz. For example, the repetition rate of the pulsed laser can be configured to be about 30 kHz. In some embodiments, the repetition rate can be modulated arbitrarily. For example, the repetition rate can be modulated between about 1 kHz and about 200 kHz. In some embodiments, generating the beam can include configuring a peak power of the pulsed laser to be above 20 GW. For example, the peak power of the pulsed laser can be configured to be about 50 GW. In some embodiments, configuring the repetition rate and/or the peak power of lasers 112, 122, and/or 132 can be based on the information about a condition of cloud 104 collected by remote sensors 116, 126, and/or 136. In some embodiments, generating the beam can include configuring other parameters of the pulsed laser, such as the wavelength, the polarization, the beam profile, and/or the pulse duration of the pulsed laser.

In some embodiments, operation 515 can be used for transmitting the beam into the cloud to induce a shock wave and/or an acoustic wave in the cloud. For example, as described with reference to FIG. 1, laser beams 114, 124, and 134 can be transmitted into cloud 104 and generate shock waves 150 and acoustic waves 160 propagating within cloud 104. In some embodiments, laser beams 114, 124, and 134 can be transmitted in at a distance into cloud 104, due to their repetition rate in the kHz range as described in operation 515. For example, the distance that laser beams 114, 124, and 134 are transmitted into cloud 104 can be between about 500 m and about 2000 m. In some embodiments, operation 515 can include adjusting the focus of the beam, as described with reference to FIGS. 3A and 3B.

In some embodiments, operation 520 can be used for steering the beam in a pattern in the cloud. For example, as described with reference to FIG. 1, laser beams 114, 124, and 134 can be steered according to a pattern, such as a helical path or a spiral path to promote shock waves 150 and acoustic waves 160 to cover a wider area in cloud 104 and vary a scale of rainfall. In some embodiments, the pattern to steer laser beams 114, 124, and/or 134 can also be in other paths, such as a straight path, an elliptical path, or an irregular path. In some embodiments, operation 520 can include steering the beam to relocate particles in the cloud, as described with reference to FIG. 4. In some embodiments, operation 520 can include steering the beam to transport cloud condensation nuclei (CCN) in the cloud.

In some embodiments, operation 525 can be used for monitoring a changing condition of the cloud. For example, as described with reference to FIG. 1, remote sensors 116, 126, and/or 136 can monitor in real-time the changing condition of cloud 104 developing in response to the laser beams 114, 124, and/or 134 transmitting into cloud 104. In some embodiments, remote sensors 116, 126, and/or 136 can monitor a development of formation of cloud droplets in cloud 104, such as the changing distribution, density, and average size of the cloud droplets due to shock wave 150 and acoustic wave 160 generated by laser beams 114, 124, and/or 134. In some embodiments, ground based station 110, ground based vehicle 120, and air based vehicle 130 can share information collected by remote sensors 116, 126, and/or 136 about the changing condition of cloud 104 in real-time. In some embodiments, monitoring the changing condition of cloud 104 can include scanning the side and/or the bottom of cloud 104. For example, as described with reference to FIG. 1, remote sensor 116 can scan a portion or an entirety of the bottom of cloud 104, remote sensor 126 can scan both the side and the bottom of cloud 104, and remote sensor 136 can scan the side of cloud 104 over a range of altitude (e.g., between about 1000 m and about 5000 m) and/or over a range of horizontal orientation (e.g., between about 0° and about) 360°.

In some embodiments, operation 530 can be used for adjusting a parameter of the pulsed laser based on the changing condition of the cloud. For example, as described with reference to FIG. 1, the parameters, the trajectories, and the steering pattern of laser beams 114, 124, and/or 134 can be adjusted in a real-time manner in response to the changing condition of the cloud according to the information collected by remote sensors 116, 126, and/or 136. In some embodiments, a transmitting orientation of laser beams 114, 124, and/or 134 or a location of ground based vehicle 120 or air based vehicle 130 can be adjusted according to the changing condition of cloud 104. In some embodiments, in response to the progress of collision-coalescence process 246 as described with reference FIG. 2 and monitored by remote sensors 116, 126, and/or 136, the parameters of laser beams 114, 124, and/or 134 can be adjusted to tune conditions of shock waves 150 and acoustic waves 160 in cloud 104. For example, if the average size of cloud droplets 242 is monitored to be growing slower than a reference growing rate, the repetition rate and/or the power of laser beams 114, 124, and/or 134 can be adjusted to promote collision-coalescence process 246. In some embodiments, a parameter of a pulsed laser on a first platform can be adjusted based on the changing condition of the cloud monitored by a remote sensing apparatus on a second platform. For example, the parameters of laser beams 114 can be adjusted according to the changing condition of the cloud at an elevated altitude monitored by remote sensor 136 (but may be beyond the monitoring range of remote sensor 116) and shared between air based vehicle 130 and ground based vehicle 120 in a wireless means.

In some embodiments, operations 525 and 530 can be performed together in real time, such that a feedback loop can continue between monitoring the changing condition of the cloud in response to the beam transmitting into the cloud and adjusting a parameter of the pulsed laser in response to the changing condition of the cloud, to promote precipitation of the cloud.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the embodiments have been described herein with reference to exemplary embodiments for exemplary fields and applications, it should be understood that the embodiments are not limited thereto. Other embodiments and modifications thereto are possible, and are within the scope and spirit of the disclosure. For example, without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the embodiments should not be limited by any of the above-described exemplary embodiments, but should be defined only in accordance with the following claims and their equivalents.

What is claimed is:

1. A method, comprising:
generating a beam from a pulsed laser, wherein:
a repetition rate of the pulsed laser is between about 1 kHz and about 200 kHz, wherein the repetition rate is adjustable; and
a peak power of the pulsed laser is between about 10 GW and about 50 GW,
wherein the peak power is adjustable;
transmitting the beam into a cloud to induce a shock wave and/or an acoustic wave in the cloud; and
during the transmitting, steering the beam in a pattern in the cloud.

2. The method of claim 1, further comprising selecting the cloud according to information collected by remotely sensing a condition of the cloud.

3. The method of claim 1, further comprising monitoring a changing condition of the cloud during the steering.

4. The method of claim 1, further comprising adjusting the pattern based on a changing condition of the cloud.

5. The method of claim 1, further comprising adjusting a parameter of the pulsed laser based on a changing condition of the cloud.

6. The method of claim 5, further comprising using the repetition rate or the peak power as the parameter.

7. The method of claim 1, further comprising inducing a collision-coalescence process in the cloud based on the shock wave and the acoustic wave.

8. The method of claim 1, further comprising:
monitoring a growing rate of an average size of cloud droplets in the cloud; and
adjusting the repetition rate in response to the growing rate less than a reference growing rate.

9. The method of claim 1, further comprising adjusting a location of a ground-based vehicle equipped with the pulsed laser or air based vehicle equipped with the pulsed laser according to a changing condition of the cloud.

10. The method of claim 1, wherein the transmitting comprises transmitting the beam towards a location on a bottom of the cloud.

11. The method of claim 1, further comprising steering the beam to transport cloud condensation nuclei in the cloud.

12. The method of claim 1, further comprising adjusting a focus of the beam.

13. A system, comprising:
a remote sensor configured to monitor a changing condition of a cloud; and
a pulsed laser configured to transmit a beam of laser into the cloud to promote precipitation of the cloud, in response to the changing condition of the cloud, wherein:
a repetition rate of the pulsed laser is between about 1 kHz and about 200 kHz; and
a peak power of the pulsed laser is between about 10 GW and about 50 GW.

14. The system of claim 13, wherein the repetition rate of the pulsed laser is adjustable based on the changing condition of the cloud.

15. The system of claim 13, wherein the peak power of the pulsed laser is adjustable based on the changing condition of the cloud.

16. The system of claim 13, wherein:
the remote sensor is equipped on an air based platform;
the pulsed laser is equipped on a ground based platform; and
a data about the changing condition of the cloud is transmitted from the air based platform to the ground based platform.

17. The system of claim 16, wherein the remote sensor is further configured to monitor the changing condition of the cloud at an altitude between about 1000 m and about 5000 m from ground.

18. The system of claim 13, wherein the pulsed laser is further configured to induce a shock wave and/or an acoustic wave in the cloud.

19. The system of claim 13, wherein:
the changing condition of the cloud comprises a change of an average size of cloud droplets in the cloud; and
the pulsed laser is further configured to adjust the repetition rate or the peak power, in response to a growing rate of the average size of the cloud droplets in the cloud being less than a reference growing rate.

20. The system of claim 13, wherein the pulsed laser is further configured to steer the beam of laser in a helical pattern.
